(19) United States
(12) Patent Application Publication
(10) Pub. No.: US 2015/0077408 A1
(43) Pub. Date: Mar. 19, 2015

(54) DISPLAY DEVICE

(71) Applicant: HON HAI PRECISION INDUSTRY CO., LTD., New Taipei (TW)

(72) Inventors: GUAN-JIUN WANG, New Taipei (TW); CHENG-CHUNG WU, New Taipei (TW)

(21) Appl. No.: 14/484,535

(22) Filed: Sep. 12, 2014

(30) Foreign Application Priority Data
Sep. 13, 2013 (TW) 102133112

(51) Int. Cl. G09G 3/36

(52) U.S. Cl. CPC G09G 3/3611
USPC 345/204; 345/87

(57) ABSTRACT

A display device includes a drive board, a liquid crystal display (LCD) panel, a multi-media board, a wireless high-definition (WiHD) receiver, and a WiHD transmitter. The LCD panel, the drive board, and the WiHD receiver are housed in a first enclosure. The multi-media board and the WiHD transmitter are housed in a second enclosure. The first enclosure and the second enclosure are separately spaced from each other. The WiHD transmitter and the WiHD receiver establishes a wireless communication channel. The multi-media board receives video data from a video source, and transmits the video data to the drive board via the wireless communication channel. The drive board generates drive signals based on the video data, and transmits the drive signals to the LCD panel. The LCD panel presents video images according to the drive signals.

### CROSS-REFERENCE TO RELATED APPLICATIONS

This application claims priority to Taiwanese Patent Application No. 102133112 filed on Sep. 13, 2013 in the Taiwan Intellectual Property Office, the contents of which are hereby incorporated by reference. Relevant subject matter is disclosed in co-pending U.S. Patent Applications entitled “DISPLAY DEVICE”, Attorney Docket Number US52297, U.S. application Ser. No. [to be advised], filed on the same day as the present application, and co-pending U.S. Patent Applications entitled “DISPLAY DEVICE AND DISPLAY METHOD”, Attorney Docket Number US52299, US Application No. [to be advised], filed on the same day as the present application.

### FIELD

The disclosure generally relates to display devices, and more particularly relates to display devices including a liquid crystal display (LCD) panel.

### BACKGROUND

Display devices are output devices for presentation of information in visual form. The display devices are commonly used as screens for a wide variety of electronic devices, such as televisions and computers.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an embodiment of a display device.

FIG. 2 is a block diagram of another embodiment of a display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features.

The description is not to be considered as limiting the scope of the embodiments described herein. It should be noted that references to “an” or “one” embodiment in this disclosure are not necessarily to the same embodiment, and such references can mean “at least one.”

The term “comprising” means “including, but not necessarily limited to”; it specifically indicates open-ended inclusion or membership in a so-described combination, group, series and the like.

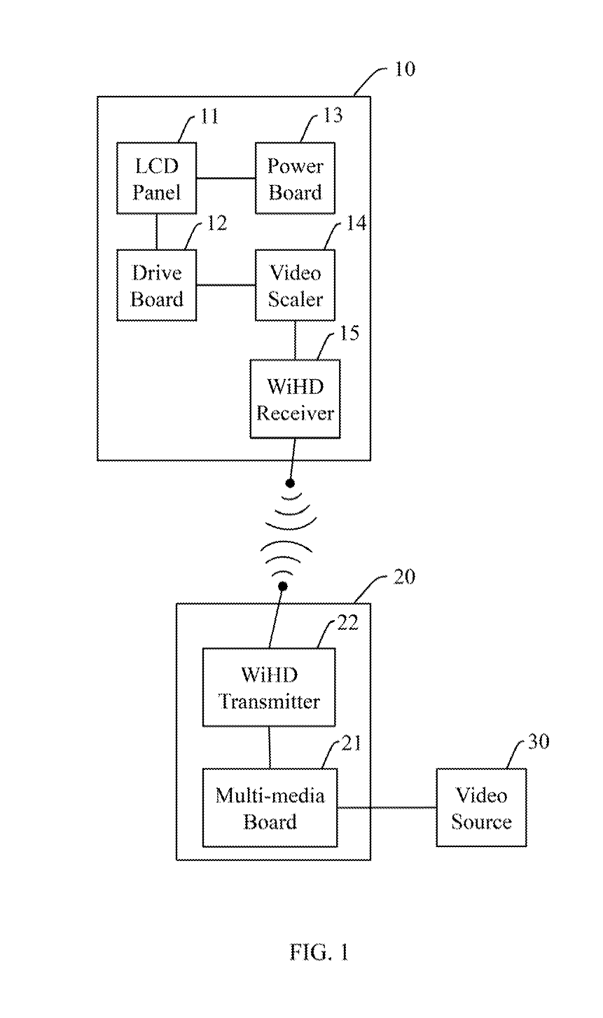

FIG. 1 illustrates a block diagram of an embodiment of a display device. The display device includes a first enclosure 10, an LCD panel 11, a drive board 12, a power board 13, a video scaler 14, a wireless high-definition (WiHD) receiver 15, a second enclosure 20, a multi-media board 21, and a WiHD transmitter 22. The display device can receive video data from a video source 30 and present video images corresponding to the video data. The video source 30 can be a television, a computer, a digital video disc (DVD) player, a gaming device, a smart phone, or any other electronic device.

The multi-media board 21 can provide an input/output (I/O) interface for communicating with the video source 30 and receive video data from the video source 30 via the I/O interface. The I/O interface can be a video graphics array (VGA) interface, a high-definition multi-media interface (HDMI), an S-Video interface, a digital video interface (DVI), or any other suitable video interface.

The WiHD transmitter 22 and the WiHD receiver 15 can establish a wireless communication channel. The multi-media board 21 can transmit the video data to the video scaler 14 via the wireless communication channel. WiHD is a unified standard which defines a specification for a digital network interface for wireless transmission of high-definition content for consumer electronics products.

The video scaler 14 can scale the video data and generate scaled video data of a dimension compatible with the LCD panel 11. The video scaler 14 can scale the video data in either a horizontal or a vertical direction. The video scaler 14 is connected to the drive board 12 and can transmit the scaled video data to the drive board 12.

The drive board 12 can generate drive signals based on the scaled video data. The drive board 12 is connected to the LCD panel 11 and can transmit the drive signals to the LCD panel 11.

The power board 13 can provide power to the LCD panel 11. The LCD panel 11 can present video images according to the drive signals received from the drive board 12.

The LCD panel 11, the drive board 12, the power board 13, the video scaler 14, and the WiHD receiver 15 are housed in the first enclosure 10. The multi-media board 21 and the WiHD transmitter 22 are housed in the second enclosure 20. The first enclosure 10 and the second enclosure 20 are separately spaced from each other.

The drive board 12 and the LCD panel 11 communicate with each other via a high-speed signal transmission interface.

When the resolution of the LCD panel 11 is lower than the Full HD resolution (1920*1080 pixels), the drive board 12 can transmit the drive signals to the LCD panel via a low voltage differential signaling (LVDS) interface. The LVDS interface can operate at low power and can run at very high speeds using inexpensive twisted-pair copper cables.

When the resolution of the LCD panel 11 is equal to or higher than the Full HD resolution, the drive board 12 can transmit the drive signals to the LCD panel 11 via a V-by-One HS interface. The V-by-One HS interface can run at faster speeds than the LVDS interface.

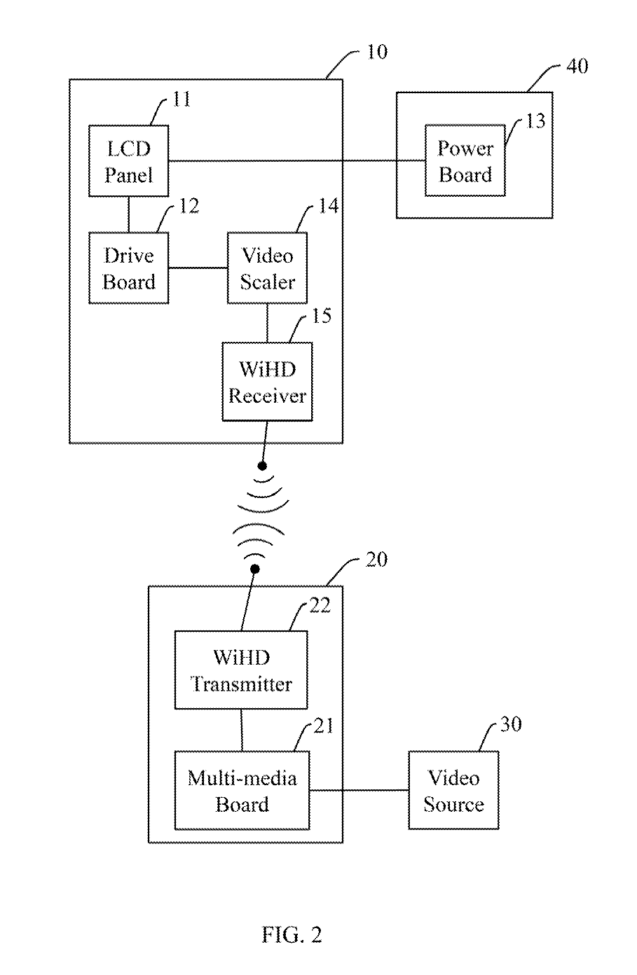

FIG. 2 illustrates a block diagram of another embodiment of a display device. In the illustrated embodiment of, the display device further includes a third enclosure 40. The LCD panel 11, the drive board 12, the video scaler 14, and the WiHD receiver 15 are housed in the first enclosure 10. The multi-media board 21 and the WiHD transmitter 22 are housed in the second enclosure 20. The power board 13 is housed in the third enclosure 40. The first enclosure 10, the second enclosure 20, and the third enclosure 40 are separately spaced from each other.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A display device comprising:
a first enclosure and a second enclosure, the first enclosure and the second enclosure being separately spaced from each other;
a liquid crystal display (LCD) panel, a drive board, and a wireless high-definition (WiHD) receiver housed in the first enclosure; and
a multi-media board and a WiHD transmitter housed in the second enclosure;
wherein the WiHD transmitter and the WiHD receiver are configured to establish a wireless communication channel, the multi-media board is configured to receive video data from a video source and transmit the video data to the drive board via the wireless communication channel, the drive board is configured to generate drive signals based on the video data and transmit the drive signals to the LCD panel, and the LCD panel is configured to present video images according to the drive signals.

2. The display device of claim 1, further comprising a video scaler housed in the first enclosure and configured to scale the video data and generate scaled video data of a dimension compatible with the LCD panel and transmit the scaled video data to the drive board, wherein the drive board is configured to generate the drive signals based on the scaled video data.

3. The display device of claim 1, further comprising a power board housed in the first enclosure and configured to provide power to the LCD panel.

4. The display device of claim 1, wherein the drive board is configured to transmit the drive signals to the LCD panel via a low voltage differential signaling (LVDS) interface.

5. The display device of claim 1, wherein the drive board is configured to transmit the drive signals to the LCD panel via a V-by-One HS interface.

6. The display device of claim 1, wherein the multi-media board is configured to provide an input/output (I/O) interface for communicating with the video source and receive video data from the video source via the I/O interface.

7. A display device comprising:
a first enclosure, a second enclosure, and a third enclosure, the first enclosure, the second enclosure, and the third enclosure being separately spaced from each other;
a liquid crystal display (LCD) panel, a drive board, and a wireless high-definition (WiHD) receiver housed in the first enclosure;
a multi-media board and a wireless high-definition (WiHD) transmitter housed in the second enclosure; and
a power board housed in the third enclosure and configured to provide power to the LCD panel;
wherein the WiHD transmitter and the WiHD receiver are configured to establish a wireless communication channel, the multi-media board is configured to receive video data from a video source and transmit the video data to the drive board via the wireless communication channel, the drive board is configured to generate drive signals based on the video data and transmit the drive signals to the LCD panel, and the LCD panel is configured to present video images according to the drive signals.

8. The display device of claim 7, further comprising a video scaler housed in the first enclosure and configured to scale the video data and generate scaled video data of a dimension compatible with the LCD panel and transmit the scaled video data to the drive board, wherein the drive board is configured to generate the drive signals based on the scaled video data.

9. The display device of claim 7, wherein the drive board is configured to transmit the drive signals to the LCD panel via a low voltage differential signaling (LVDS) interface.

10. The display device of claim 7, wherein the drive board is configured to transmit the drive signals to the LCD panel via a V-by-One HS interface.

11. The display device of claim 7, wherein the multi-media board is configured to provide an input/output (I/O) interface for communicating with the video source and receive video data from the video source via the I/O interface.
